(19) United States
(12) Patent Application Publication
(10) Pub. No.: US 2005/0149289 A1
(43) Pub. Date: Jul. 7, 2005

(54) Method for performing a reactive hazard incident review and feedback to safety analysis of a product or system

(75) Inventors: Kennenth Neil Whaling, Simpsonville, SC (US); Eric Stephen Keufman, Simpsonville, SC (US)

Correspondence Address: NIXON & VANDERHYE P.C./G.E., 1100 N. GLEBE RD., SUITE 800, ARLINGTON, VA, 22201, US

(73) Assignee: General Electric Company, Schenectady, NY (US)

(21) Appl. No.: 10/751,490

(22) Filed: Jan. 6, 2004

(51) Int. Cl. G06F 15/00

(52) U.S. Cl. 702/181

(57) ABSTRACT

A method for analyzing a product for safety in view of a safety incident associated with the product including: comparing the safety incident to a plurality of previously analyzed safety incidences stored in safety documentation for the product and selecting one of said safety incidences based on the comparison; conducting an accident scenario review (ASR) of the safety incident using an existing ASR template previously developed for the selected stored safety incidence; tailoring the existing ASR template to reflect to suit the ASR for the safety incident; based on the accident scenario review, identifying at least one corrective action which avoids or mitigates future occurrences of the safety incident, and updating the safety documentation to include the tailored ASR template developed for the safety incident.

### BACKGROUND OF THE INVENTION

This invention relates to safety analysis of a product or system. More particularly, it relates to a method for conducting an analysis of a product or a system to evaluate risk(s) to personnel or equipment and identify mitigating conditions that may control or avoid such risks.

A variety of different processes have been used in the past to determine safety of various systems. These processes are often introduced after the occurrence of a catastrophic event or after the occurrence of a consistent series of events resulting in harm to personnel.

Preliminary hazard assessment (PHA) had origins from a combination of generic industry hazard checklists. These checklists required identification of inherent hazards, which a test applicant must address specifically in a subsequent review session. One of the shortcomings of this process involves the task of addressing the risk that was left entirely to an applicant—in any style deemed appropriate to the applicant's knowledge. Thus, the documentation of the approach and the results greatly varied and required additional time and resources to ensure completeness. Also, gathering information with respect to critical hazardous features and combinations depended on an initial reviewer's expertise.

Hazard characterization and personal safety analysis involves examination of hazards associated with a job or a task. In this technique, workers are grouped so that risks and exposures experienced by any member of a group are representative of the group as a whole. Information about the nature of a workplace, equipment and materials used, and the tasks to be performed may be considered as the basis of this step.

In another approach, a preliminary assessment of hazards require a minimal effort to identify the inventory of hazardous materials to perform an initial hazard categorization. Reviewing basic facility information on intended facility operations and using estimates of materials may lead to an acceptable assessment. Hazard characterization also uses information from existing hazard analysis documentation such as, for example, safety analysis reports, process hazard analysis, job safety analysis (JSA), and the job hazard analysis.

Hazards are identified and resultant risks are assessed by considering probability of occurrence and severity of consequence. System safety is part of the overall program risk management decision process. Severity is an assessment of the worst potential consequence, defined by degree of injury or property damage, which could occur. For example, hazard severity may be categorized as: catastrophic, critical, marginal and negligible.

Factors for identification of hazards include, for example, (a) identification of hazardous components, (b) identification of hazardous operating conditions, (c) safety related interface considerations, (d) environmental constraints including operating environments, and (e) training and certification pertaining to hazardous and safety critical operations and maintenance of hazardous and safety critical systems, etc.

Hazardous operations review analysis is performed to evaluate activities for hazards or risks introduced into a system by operational and support procedures. These analyses are also performed to evaluate the adequacy of operational and support procedures that are used to eliminate or control identified hazards or risks. Typically, hazards are identified and evaluated by considering such criteria as plan system configuration and state at each phase of an activity, facility interfaces, and supporting tools including software controlled automatic test equipment, to name but a few. Human factor(s) may be considered as an element of the total system, receiving both inputs and initiating outputs during the conduct of the analysis.

Safety efforts related to the hazardous operations review process focus primarily on the safe operation of a system. This process focuses on the operational phase of the system with specific emphasis on single-point failures. This process is not easily implemented for multiple system and multiple point failures.

There is a need for a structured, standardized and efficient methodology for conducting a thorough analysis of a single product or a complex system to evaluate risk(s) to personnel and equipment, and identify mitigating factors to reduce the identified risk(s). There is also a need for a safety methodology applicable for proactive preventative analysis of a product to identify potential hazards before an accident occurs, and which also assists with reactive safety reviews of incidents that have occurred.

### BRIEF DESCRIPTION OF THE INVENTION

A structured, standardized and efficient methodology has been developed for conducting an effective analysis of a product or a complex system to evaluate the risk to personnel and equipment safety. Further, the methodology identifies and implements mitigating factors to control possible risks to personnel and equipment. In addition, the methodology includes proactive analytical process to evaluate perceived hazards for new products, and a reactive analytical process to evaluate safety incidents that occur with existing products.

The proactive safety review process combines preliminary hazard assessment, hazardous operations review, and accident scenario review processes into a unique systemic series of actions. The present method further provides the flexibility to invoke and execute the safety review process at almost any stage in the development of a new product, or the use of an existing product.

Specifically, the proactive safety review analyzes, using a preliminary hazard assessment, a system or product to identify inherent hazards associated with the system or product. Of the inherent hazards, those hazards that are safety-compromising are identified in a hazardous operations review. Safety-compromising hazards are analyzed to rate the severity of the potential unsafe condition. Predetermined and established operating parameters of the product are considered, along with deviations from those established operating parameters. With respect to a deviation for an operating parameter, the possible safety consequences of the deviation are considered. This process is repeated until all the factors contributing to credible single-point failures and unsafe conditions are considered.

A system or product is also evaluated for a multi-system or multi-point failure using an accident scenario review if an identified unsafe condition is of sufficient severity, is associated with a plurality of components of the system, or is associated with various distinct systems. In the case of a multi-system or multi-point failure, a thorough analysis of mitigating factors is performed to stop progression of the risk(s). Additional control measures are adopted to further reduce the likelihood of occurrence of potential hazards. This process is repeated until the overall risk level is found to be acceptable.

The reactive safety incident review includes conducting an accident scenario review to determine the cause(s) of an accident or other safety incident of an existing product being used in the field. The accident scenario review is conducted using initially the documentation generated during the proactive active safety review analysis in addition to the facts and events of the specific incident. The results of the safety review analysis of the accident or other safety incident include determinations of corrective actions to be taken to avoid future recurrences of the accident. In addition, the results of the safety review analysis are applied to revise the proactive accident safety review and hazardous operation analysis to better predict (for future products) the type of accident that actually occurred.

The invention may be embodied as a method for analyzing a product for safety in view of a safety incident associated with the product, said method comprising: comparing the safety incident to a plurality of previously analyzed safety incidences stored in safety documentation for the product and selecting one of said safety incidences based on the comparison; conducting an accident scenario review (ASR) of the safety incident using an existing ASR template previously developed for the selected stored safety incidence; tailoring the existing ASR template to reflect to suit the ASR for the safety incident; based on the accident scenario review, identifying at least one corrective action which avoids or mitigates future occurrences of the safety incident, and updating the safety documentation to include the tailored ASR template developed for the safety incident.

The invention may also be embodied as a method for analyzing a product for safety in view of a safety incident associated with the product, said method comprising: record the safety incident in safety documentation for the product; determining whether the safety incident has a severity level above a threshold severity level before proceeding; comparing the safety incident to a plurality of previously analyzed safety incidences stored in the safety documentation and selecting one of said safety incidences based on the comparison; developing an accident scenario model of the safety incident using as a template an existing accident scenario model developed for the selected safety incidence; identifying at least one corrective action which avoids the causation of the safety incident, and updating the safety documentation to include the accident scenario model developed for the safety incident.

### BRIEF DESCRIPTION OF THE DRAWINGS

FIG. 1 is a high-level block diagram of a product/system safety review process having proactive and reactive analyses.

FIG. 2 is a high-level block diagram of a proactive analysis of the safety review process.

FIGS. 3 to 5 show a high level flowchart to identify and mitigate hazards related to a product or system in accordance with an exemplary embodiment of the present invention.

FIGS. 6 and 7 show a detailed flowchart illustrating the process steps of a preliminary hazard assessment to identify inherent hazards associated with a product or system in accordance with an exemplary embodiment of the present invention.

FIGS. 8 to 10 show a detailed flowchart illustrating the detailed process steps to perform a hazard operations review to identify single point failures associated with the inherent hazards associated with a product/system in accordance with an exemplary embodiment of the present invention and as illustrated in FIG. 3.

FIGS. 11 to 14 are a detailed flowchart illustrating the process steps for identifying multi-point failures based upon the single point failures of the hazardous operations review and determining if the overall risk is acceptable in accordance with an exemplary embodiment of the present invention.

FIG. 15 is a high level flowchart showing a modified process, as shown in FIGS. 3 to 5, in which single and multipoint failures are evaluated.

FIG. 16 illustrates a system and process to store in a database the results of a safety review.

FIGS. 17 and 18 is a high level flow chart illustrating the process steps for reacting to an accident by conducting an accident scenario review, determining corrective actions to avoid future accidents and documenting the accident scenario review.

### DETAILED DESCRIPTION OF THE INVENTION

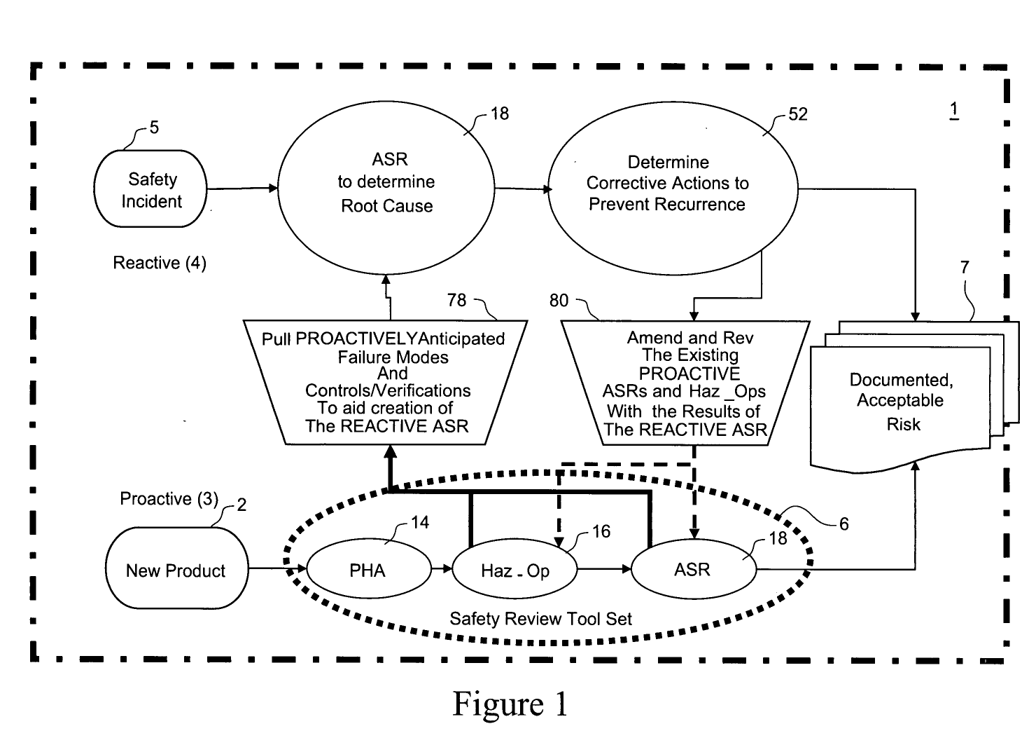

FIG. 1 is a high-level block diagram of a safety review process 1 for a product 2. In addition to products, the review process is applicable for evaluating the safety of new systems and methods. The safety review process includes a proactive analysis 3 to evaluate, for example, the product during the product design or approval stage, and before accidents have occurred during the use of the product. The proactive analysis may also be performed on an existing product that is undergoing redesign or that has not previously been subjected to the safety review process. The process 1 also includes a reactive analysis 4 to evaluate a safety incident 5, e.g., an accident, associated with the use of the product 2.

The proactive analysis 3 sequentially includes: a preliminary hazard assessment (PHA) 14 to identify inherent hazards related to the use of the product 2; a hazardous operation review (Haz_Op) 16 to evaluate a singular system or sub-component, the identified hazards, and develop techniques and designs to reduce the likelihood of single point failures, and an accident scenario review (ASR) 18 to determined whether the product (after being evaluated by the Haz_Op) is likely to have associated high severity accidents. The analytical process performed during the PHA, Haz_Op and ASR and the result of the process are documented 7 for use in future safety reviews. The proactive analysis 3 may be applied to before accidents occur during use of the product. The PHA, Haz_Op and ASR analyses form a safety review analytical tool 6 that can be applied to future safety reviews of the product and, with modification, to safety reviews of other products.

When a safety incident occurs, the safety review analytical tool 6 may be employed to evaluate the safety incident 5 that occurs in connection with a product. An accident safety review (ASR) 18 is convened and conducted to evaluate the incident 5 and determine its causation. During the ASR, the review committee may access the documentation 7 from prior safety review(s) 6 of the product. The documentation allows a safety committee to compare the anticipated failure modes previously considered to the accident 5, and the controls and verifications previously developed for the anticipated failure modes. Upon completion of the ASR, a determination 8 is made as to appropriate corrective actions, e.g., changes to product design, product procedures and product warnings. These corrective actions are intended to avoid a future occurrence of the safety incident. In addition, the documentation 7 is updated by, for example, modifying the documented hazard operations review and accident scenario review to take into account the results of the accident scenario review for the accident 5 that actually occurred.

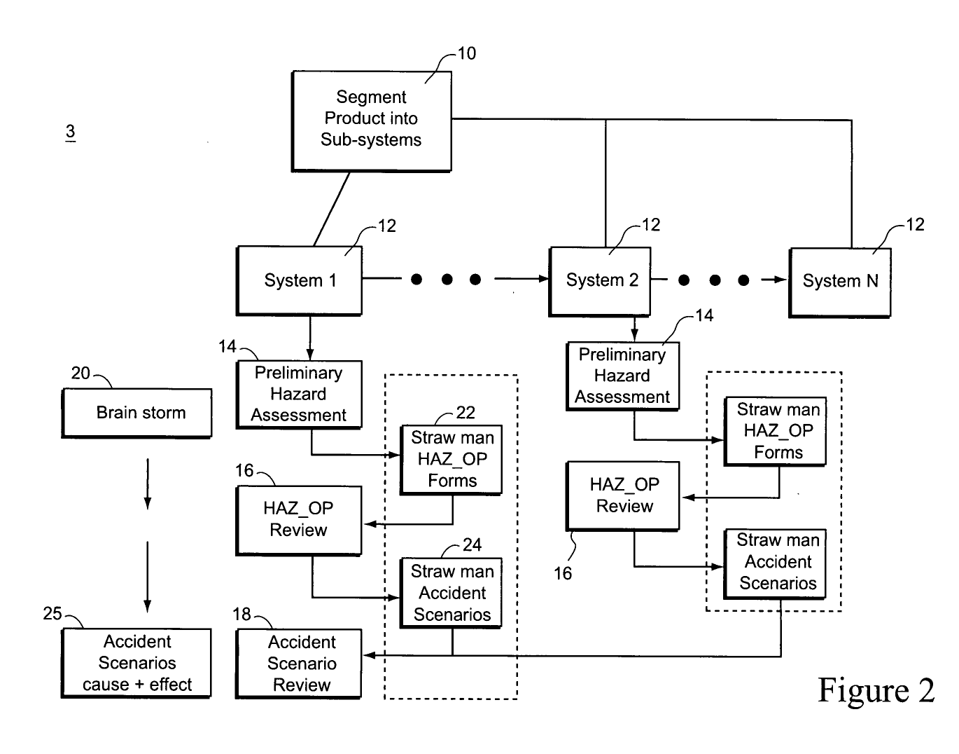

FIG. 2 is a block diagram of a three-step safety proactive review process 3 to evaluate hazards for a product, system or method (collectively referred to as the product). In a first step 10, the product is segmented into sub-systems or sub-components, if necessary. Each sub-system or sub-component 12 is individually analyzed for safety using a three-step process that generally includes a preliminary hazard assessment 14, hazardous operations review 16, and an accident scenario review. The hazard assessment 12 and hazardous operations review 14 may be applied individually to each sub-system 12, and the accident scenario review 18 may be applied to the product as a whole.

The preliminary hazard assessment may be conducted by a safety review team as a “brainstorming session” 20 to identify the inherent hazards associated with the product and its operation. A determination is made as to whether any of the inherent hazards might become a safety compromising hazard. If a credible safety compromising hazard is identified, the process proceeds to a hazardous operation review. Using the results of the preliminary hazard assessment 14, a listing of hazardous operations and potential single point failures may be generated and defined as a straw-man HAZ-OP table 22. Hazardous operations reviews 16 are considered to identify the of potential single point failures that may expose identified hazards. The hazardous operations taken from table 22 are analyzed in the review process 16. Straw-man accident scenarios 24 are prepared based on the results of the hazardous operation review 16 if the hazardous operation review identifies a potential resulting unsafe condition of high severity. An accident Scenario Review 18 evaluates the overall risk of high severity unsafe conditions occurring using a cumulative cause-effect analysis of single and multiple point failures. The straw-man table 22 and straw-man accident scenario 24 may be prepared by “facilitator(s)”, who may be independent of the persons conducting the safety review for each sub-system. The facilitators may oversee the entire review process 3.

A safety review team may comprise the following persons:

Facilitator: A person(s) charged with ensuring that the safety review process steps are followed, the documentation is kept in a consistent manner, and ensuring that the meetings are focused on relevant subject matter.

Owner: A person(s) having technical ownership of a product. The owner has responsibility of providing technical understanding of the subject (product or process or system), and is authorized to implement direct change to the product or process if necessary. Additional owners from other sub-systems or components that interface with the present system, may also be required. For example, interface owners may come from quality control, manufacturing, sourcing, transport, etc. and are deemed necessary to cover critical to safety topics.

Reviewers: People with experience in the field(s) associated with the subject. Reviewers are charged with having expertise in technical, legal, environmental, health and safety issues, to name a few. The members of the review team provide necessary checks and balances in reviewing the hazards associated with the subject. Reviewers also assure critical review of the controls and verifications that are in place to mitigate the hazards of a subject. Further, reviewers provide state-of-the-art knowledge capability to implement additional controls or verifications.

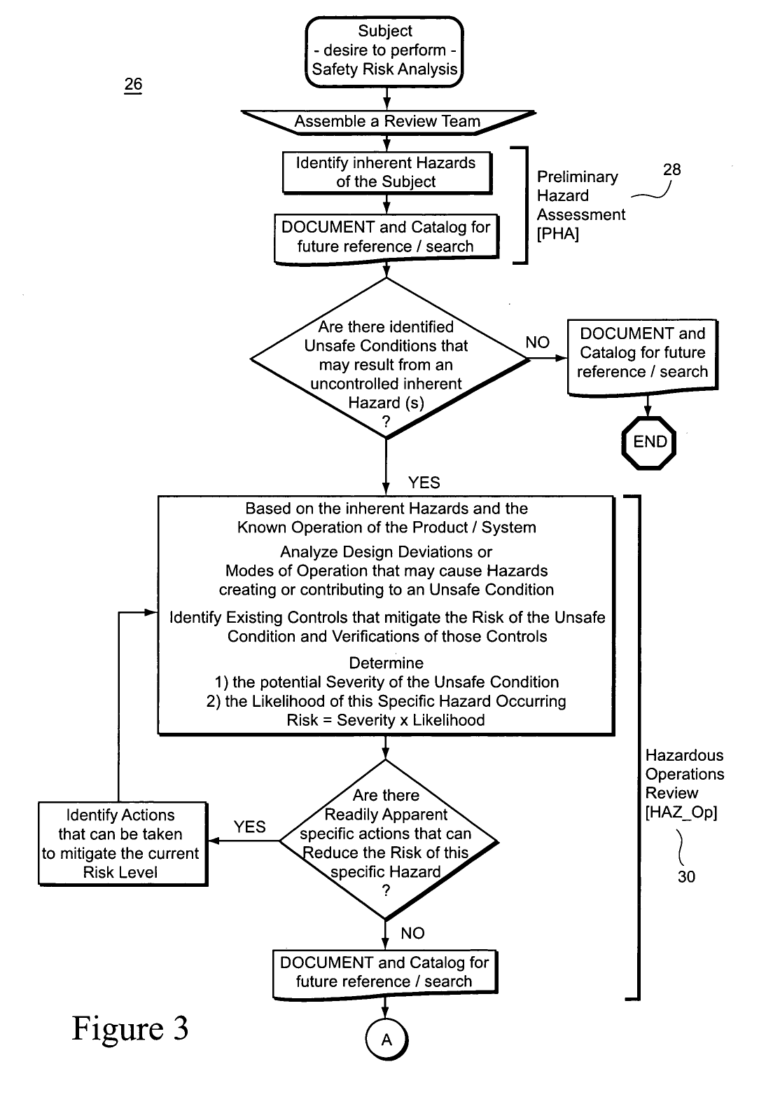

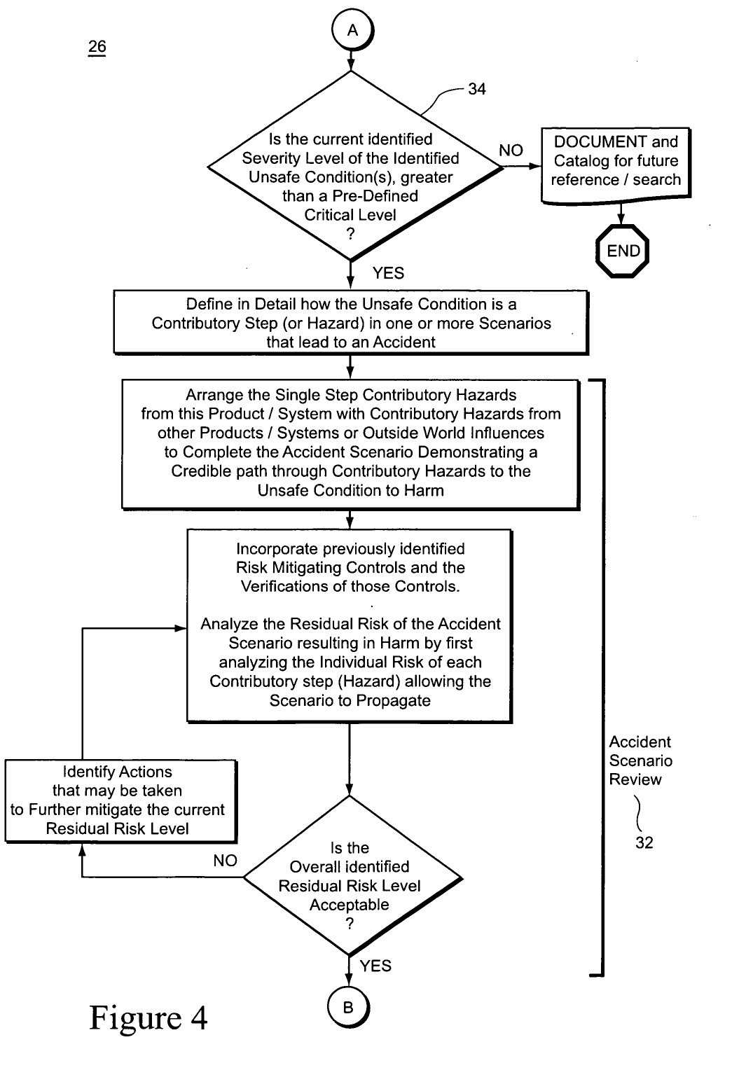

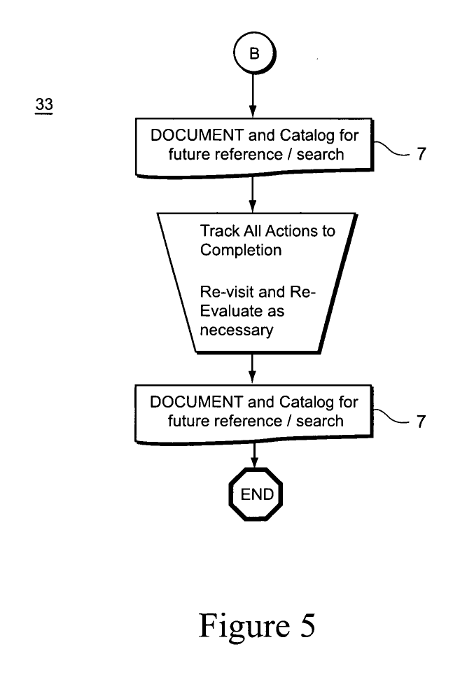

FIGS. 3 to 5 show a high-level flow-chart 26 illustrating an overall hazard review and safety process comprising steps to identify inherent hazards of a product and determine if the measured risk level due to the identified hazards is within predetermined risk levels.

The overall hazard review and safety process shown in FIGS. 3 to 5 is grouped into a preliminary hazard assessment (PHA) sub-process 28, a hazardous operations review (Haz_Op) sub-process 30, and an accident scenario review (ASR)sub-process 32. These sub-processes form a safety review tool set 16. Each of these sub-processes are described in further below and in connection with the additional figures.

The Preliminary hazard assessment (PHA) identifies the inherent hazard(s) of a sub-system of the product. Once inherent hazards are identified, single-point failures based on each identified hazard are determined. If the determined risk level is within predetermined values, those values are documented. However, if the determined risk level is not within predetermined values, then mitigating factors to control the single-point failures are identified.

A determination is then made to identify if a hazard is related to a high severity, unsafe condition. Such conditions may be the result of multi-point failures, e.g., when a hazard spans several sub-systems or components of a product. If a high severity, unsafe condition is identified, then a thorough analysis of the affected sub-systems or components of the product is performed and mitigating factors to prevent the high severity, unsafe condition are determined. A further determination is made to identify if the overall risk level of a product under review is acceptable or not. If the overall risk level is found to be acceptable, then such information is documented and the method ends. If not, the process is repeated until the overall risk level is found to be within acceptable limits.

At the completion of the hazardous operations review 30, a determination is made as to whether the current identified severity level of the identified unsafe condition(s) is greater than a pre-defined critical level 34. The predefined critical level is set by the facilitator, owners, reviewers and/or by company standard. If the identified unsafe conditions are no greater than the critical level of severity, the overall hazard review and safety process is documented and completed. The overall process is terminated based on a recognition that there is an acceptable level of hazard risk. Some remaining level of risk cannot be easily avoided and exists in all safe products and safe systems. Once this acceptable level of hazard risk is achieved, the overall process is completed and the product or system may be deemed safe. However, if the unsafe condition has a high severity rating, then the hazard review and safety process continues to the accident scenario review 32. At the completion of the process, the analysis is documented 33 for reference in future safety reviews.

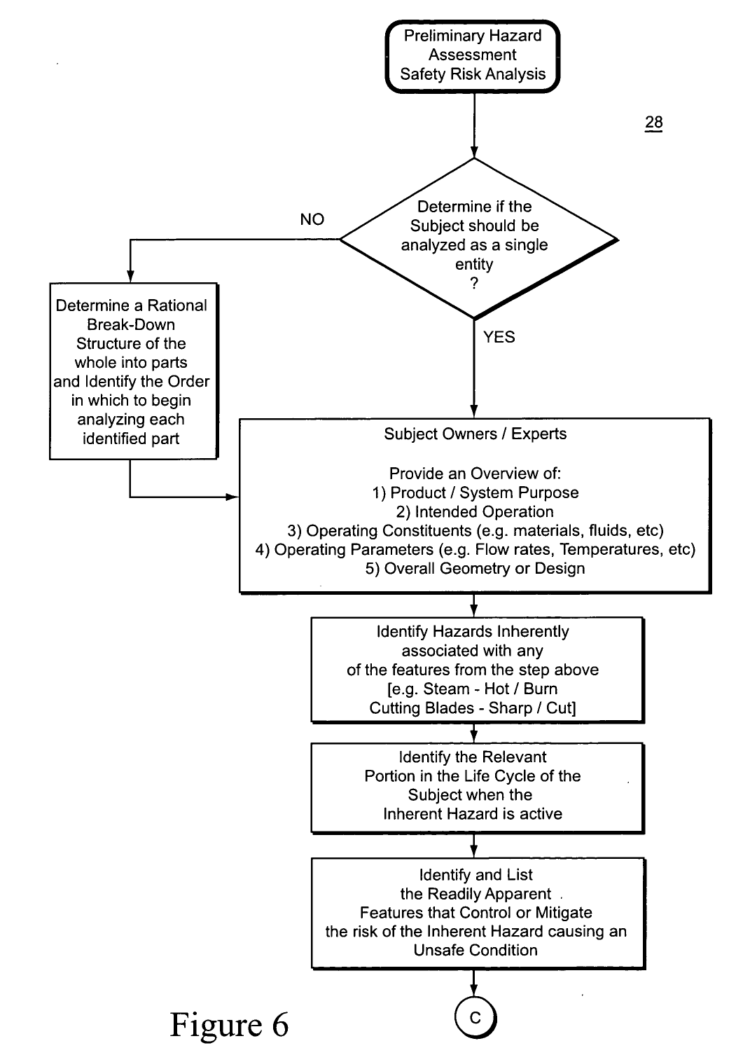

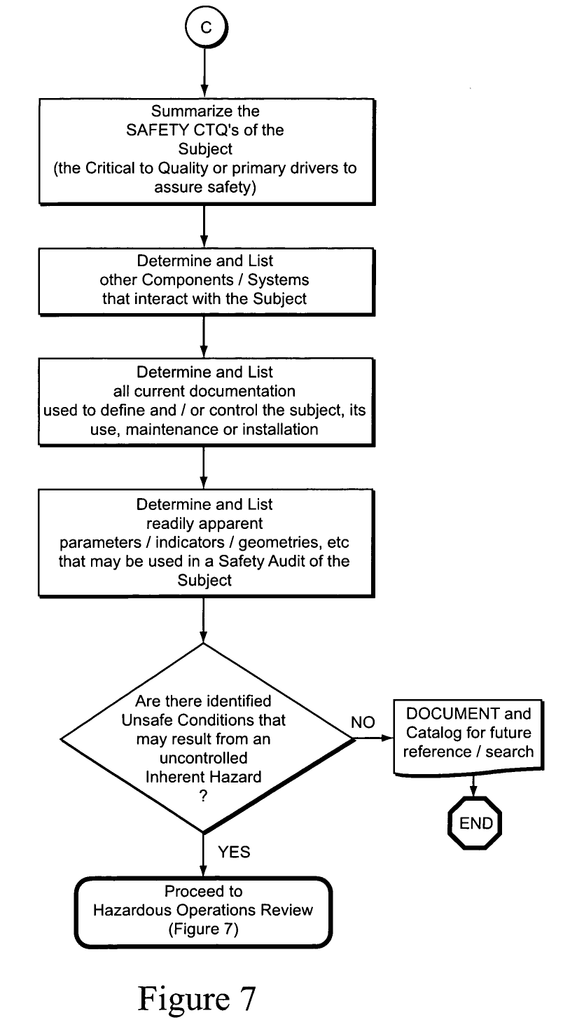

FIGS. 6 and 7 show a detailed flowchart illustrating the process steps for the sub-process of the preliminary hazard assessment 28 that identifies inherent hazards associated with a product in accordance with an exemplary embodiment of the present invention. The preliminary step of this process 28 determines if a product may be analyzed as a unit, or whether the product should be analyzed in sub-systems or sub-components. During the preliminary hazard assessment, a structured brainstorming activity may be performed to highlight inherent hazards associated with the product. During this initial step, second objectives may also be collected. The second objectives assist in determining the features of the product that are already in place that mitigate risks and control inherent hazards. This step of obtaining secondary objectives may be accomplished by working through the format of a questionnaire.

An exemplary questionnaire may ask owners to describe in detail the product, or its sub-system and components, using drawings, diagrams, tables, or other descriptors. This process may familiarize or re-familiarize the owners and the reviewers of the product. The owners of the product may then have to go through a pre-assembled list of generic inherent hazards tailored to the industry or the product field. During this familiarization step, the owners may work with a facilitator to identify generic inherent hazards related to the product. The resulting tailored list allows the owners to focus only on relevant hazards. Typically, there may be three life cycle categories that the hazards may occur. Examples of life cycle categories include installation, operation, maintenance for industrial equipment, and manufacture, use, disposal for a consumer product. A determination is made to identify the relevant portion of the life cycle of the product or system, where the hazard may occur. The description of how the hazard occurs may be determined via a group discussion. Additionally, the cause of the hazard and current known features that are in place in order to control or mitigate the hazard may be listed.

During the preliminary hazard assessment step 28, the owners of a product may be asked to summarize the key safety assuring goals associated with the subject product or system. This step may result in a concise statement as to how identified inherent hazards are required to be controlled or mitigated. For example, the primary safety critical factor of a pressure vessel is to retain structural integrity over time. This desirable feature may be ensured through attention to creep failure margins of the vessel during the design process.

Following the step of identifying the key safety control and mitigation features, the owners may be asked to list other components, sub-systems that interact with the subject product in order to determine if the other sub-systems are affected by the hazards identified with respect to the current sub-system. A list is also created identifying the current documentation which includes, for example, design practices, industry codes and standards, instruction manuals, and other documentation that are currently used to control the subject product or system.

The owners are asked to list key items that can be verified as a final check in order to ensure that safety features are established and in place. These are typically known as operational readiness review items (ORR). Examples of ORR may include a pop-up button on the sealed food container, a red tag on a safety critical aerospace feature, or a correctly run vent line on an industrial fuel system.

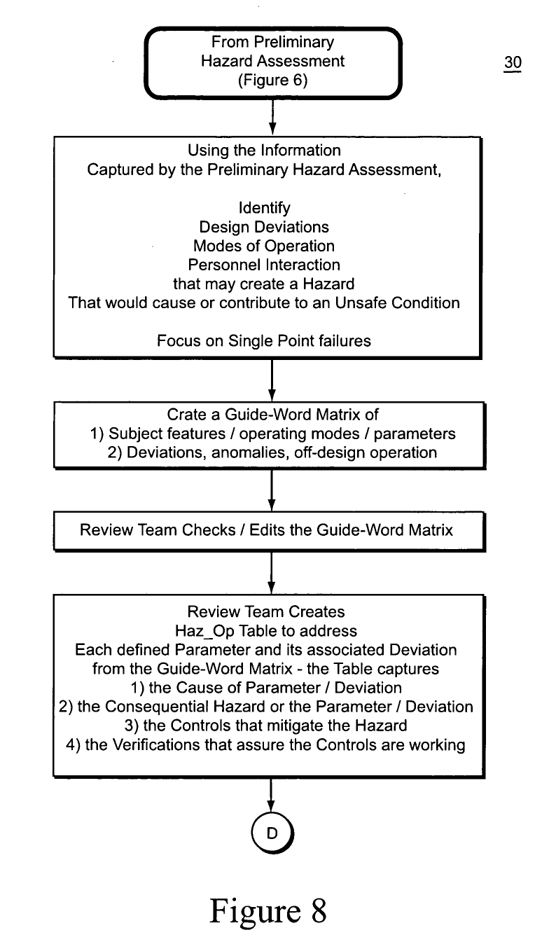

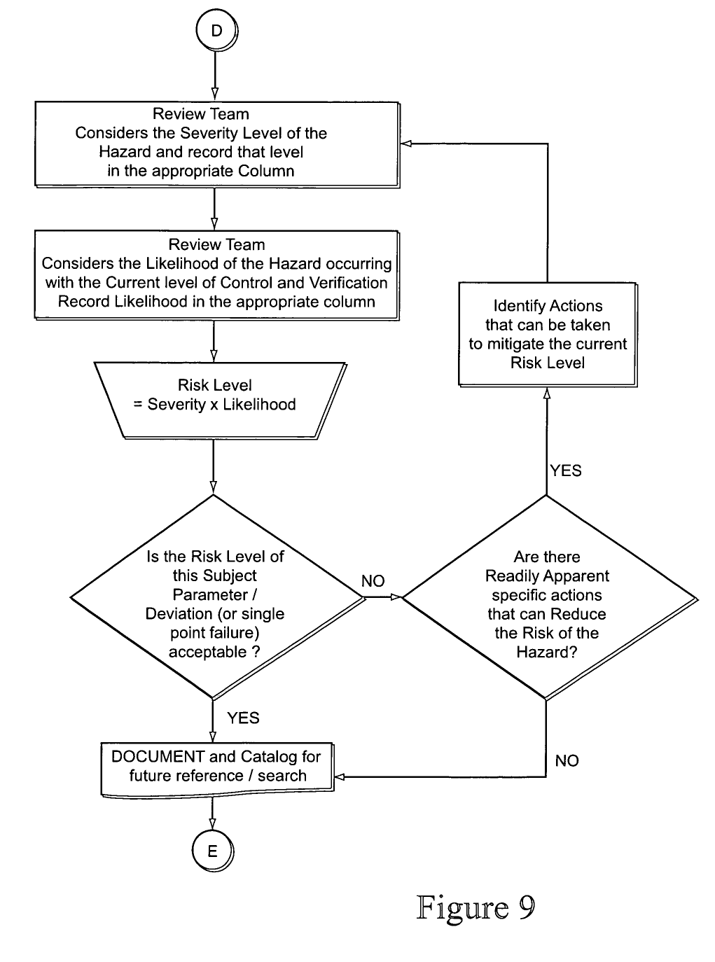

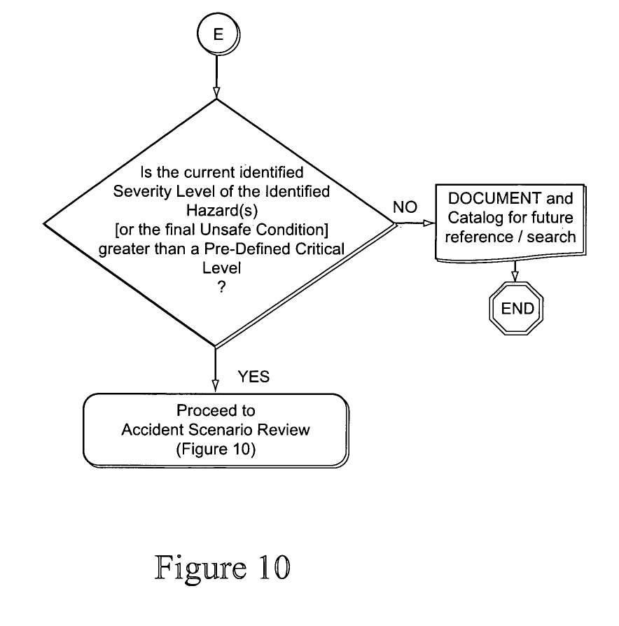

FIGS. 8 to 10 show a detailed flowchart illustrating the process steps to perform the sub-process of hazard operations review 30 that further defines potential safety comprising hazards associated with a product. The second set of the safety review process methodology performs hazardous operations review drawing initial information from the preliminary hazard assessment. During this step, parameters or deviations based upon the basic operating parameters of a product or system are identified in order to determine off design or single-point failure mechanisms that might result in safety issues.

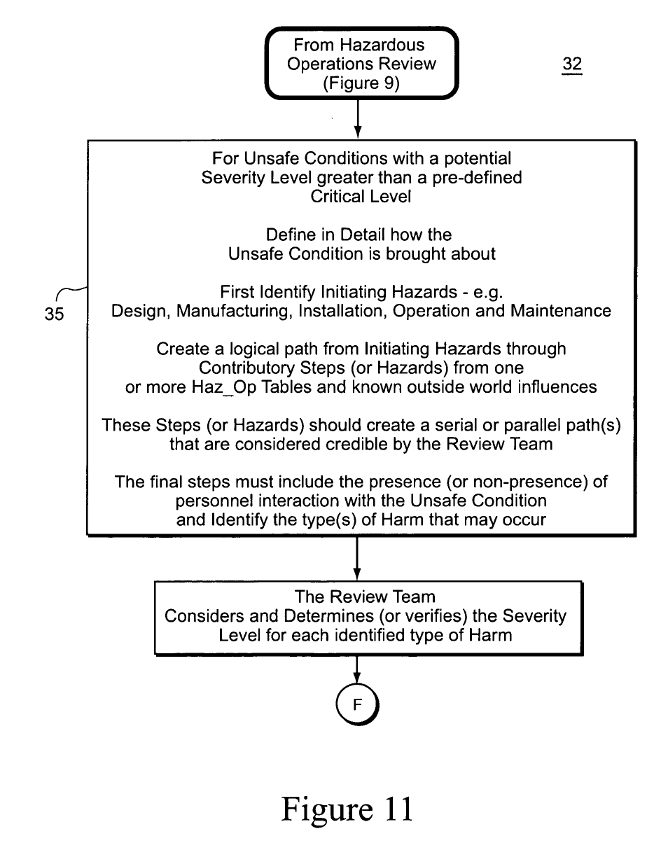

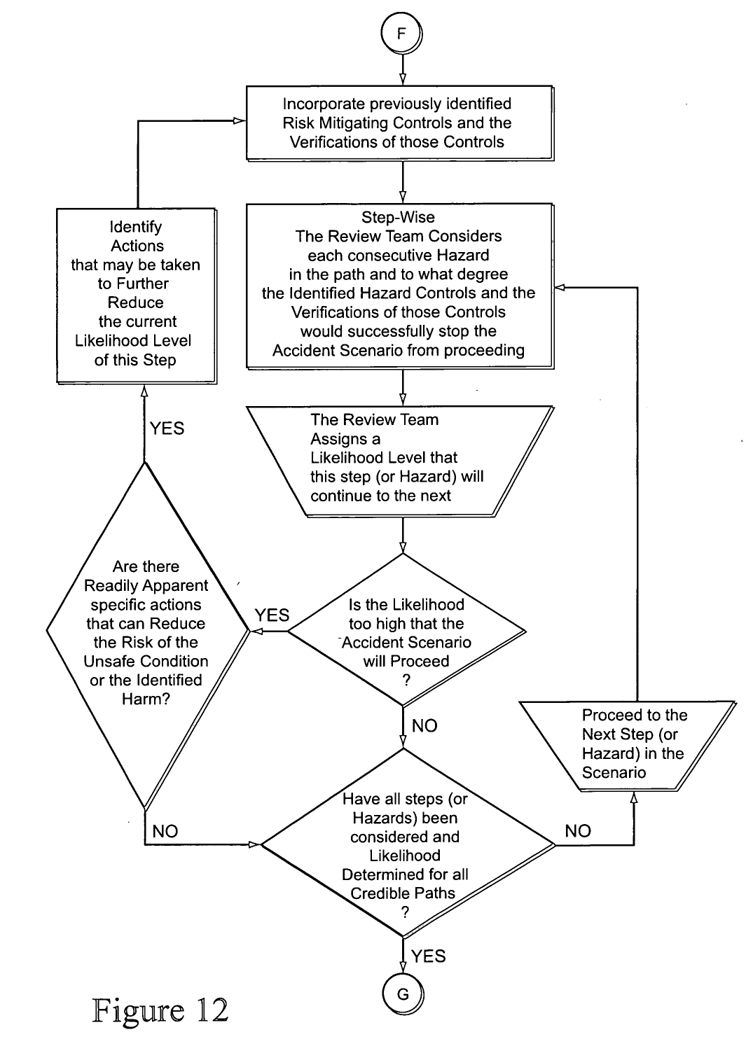

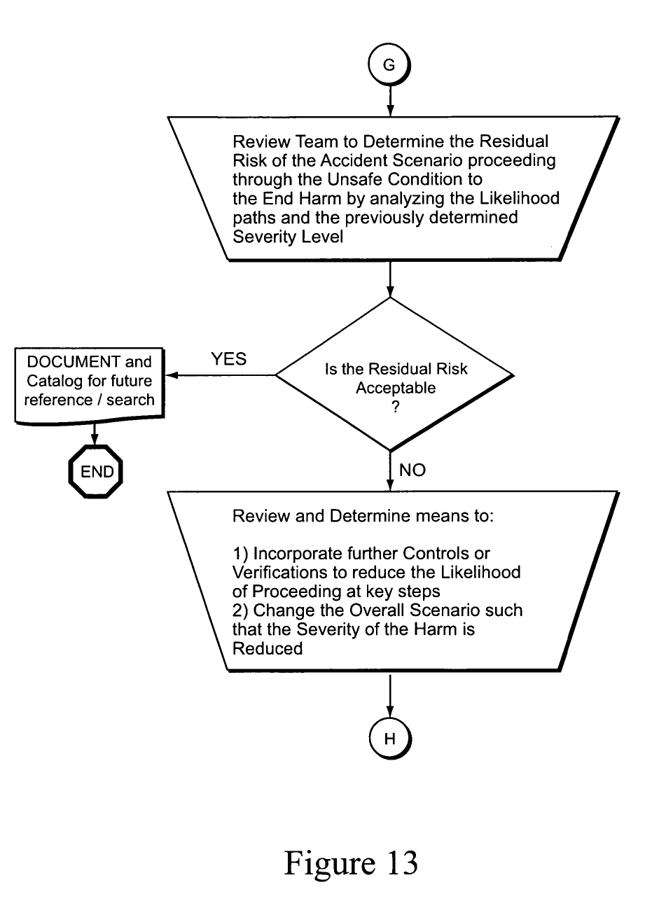

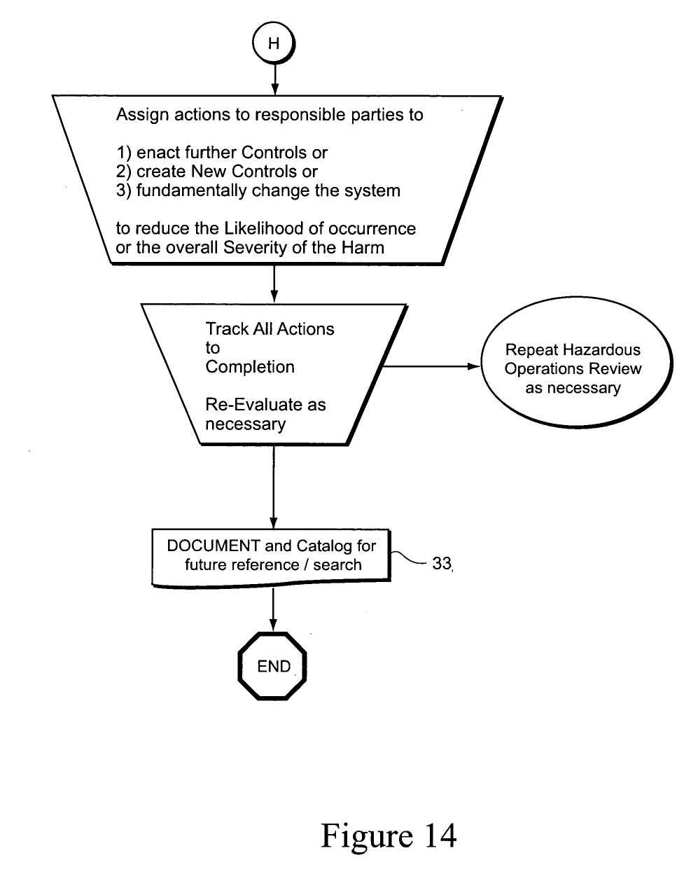

The facilitator may assemble information necessary to create an intermediate or strawman hazardous operations table from a preliminary hazardous assessment document. During this step, various product parameters and deviations from these parameters that may compromise the safety of the product or system are identified. In the event that the severity level of the associated unsafe condition is above a critical level, the safety review process methodology of the present system is expected to perform a third additional step of the accident scenario review in their review as illustrated in FIG. 11 to 14.

The basic operating parameters of a specific product usually make up the primary parameters responsible for potential hazards. Subsequently, for each parameter, a deviation or a set of deviation words are chosen for some off design or unintended situations.

The basic operating parameters and their deviations are usually based on a single-point failure mechanism that a review team is expected to consider. A strawman hazardous operations table is, for example, a matrix comprising the parameter/deviation of the product, the cause of the condition, the immediate consequence of the condition (which may not necessarily be safety compromising) and a further potential foreseeable consequence (safety compromising) that may require separate failures. Within the matrix is also columns to record the controlling features to reduce the chance for the single point failure or mitigate the consequence, and a column to record the verifications ensuring the controls are in place and effective. Finally columns are provided for the review team to capture the likelihood of the single point failure, as well as the severity of the immediate and potential consequences. Each separate single point failure requires a separate line or row in the matrix. The strawman hazardous operations table is completed ahead of the hazardous operations review process to the extent possible with additional information from the owner of the product in addition to the preliminary hazard assessment format. The step of creating a strawman hazardous operations table may increase the efficiency of a review team meeting.

A formal review is then executed with a review team working stepwise through the straw-man table confirming or altering the figures identifying parameter, deviation, cause, consequence (e.g. the unsafe condition), controls, and verifications relating to a hazard. The review team, upon reviewing each raw entry in the hazardous operations table, rates the severity of the potential unsafe condition that may occur. The review team then determines the likelihood of the consequence occurring given the current controls and verifications that are in place. In order to maintain consistency with other review processes, the safety review process of the present invention involves “severity” and “likelihood” ratings related to an existing standard.

After obtaining a ranking score or risk level for each single-point failure, the review team then determines if the current safety ranking of each single-point failure is adequate or whether further control or mitigation steps are required. If it is determined that further control or mitigation steps are deemed necessary, the required steps are recorded in an action item assigned to a person to mitigate the potential risks. After the action item is assigned and executed, the safety review team determines if a reduction in severity or likelihood of hazard occurrence has occurred. This information is recorded and stored.

During the hazardous operations review process 30, if an unsafe condition is determined to have a severity level above the predefined critical level, then an accident scenario review (ASR) 32 is performed to adequately ensure the safety of the overall product or system. This additional step is often required when direct human interaction is considered. In determining whether to proceed with this additional ASR step, the safety review team may be required to decide whether the severity is high enough to warrant further effort to reduce hazards. The severity rating of the unsafe condition may be recorded first before the accident scenario review is assembled.

FIGS. 11 to 14 show a detailed flowchart illustrating the process steps for the sub-process accident scenario review (ASR) 32 that identifies high severity failures that may involve multiple single point failures, and determines if the overall risk is acceptable. The ASR step provides a detailed final analysis to understand the steps that lead to a high severity unsafe condition, and an understanding of the inter-related safety critical features that are in place in order to stop the progression of the scenarios leading to the unsafe condition.

The contributory hazard steps are identified 35 that may lead to the unsafe condition. These steps are most often a series of single-point failures identified during the hazardous operation review. Additional human factor steps, such as, confusion over switches or lack of training, may be taken into account in determining contributory hazard steps.

During each step of this ASR process, the controls and verifications, which may be identical to the control and verification steps as identified with respect to the hazardous operations review step, may be listed. At each ASR step, the review team determines the likelihood of progressing to the next step.

As a final consensus, the safety review team determines at the end of ASR process, whether the scenario as a whole is adequately controlled, and whether the overall-risk level is acceptable. If the overall risk level is unacceptably high, then actions are considered to increase controls or verifications that may reduce the risk level. If the risk level is unacceptable and further controls or verifications do not reduce the risk, the redesigning of the product may be considered. If the overall risk level is acceptable, information obtained in the ASR process is documented 33 and stored. This information may be used as a template in the event of future changes to a product, or when similar products are created.

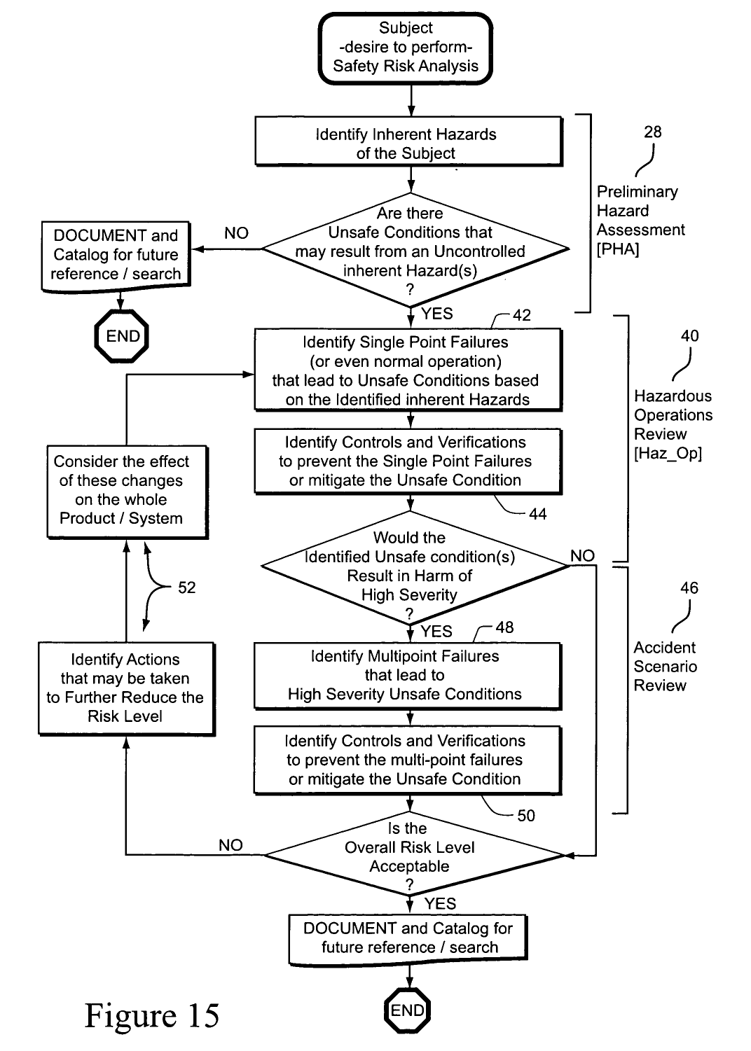

FIG. 15 is a high level flowchart showing a modified process in which single and multipoint failures are evaluated. After conducting a preliminary hazard assessment 28, a hazardous operations review 40 is conducted which is identical to the Haz_Op review 32. For each single point failure, that may cause a hazard, features of the product, e.g., product components or operational steps of the product, are identified that could be modified to prevent or mitigate the single point failure, in step 44.

During the accident scenario review, step 46, the modified process identifies and evaluates multipoint failures of the product, step 48, that may lead to an unsafe condition. A multipoint failure is, for example, a condition where two or more structural parts of a product fail or whether two or more standard operating procedures for the product do not occur or are preformed improperly, or some combination of failures of parts and procedures. Potential multipoint failures may be identified by considering the likelihood that two or more of the identified potential single point failures could occur together and result in an unsafe condition, that would not have resulted due to any one of the single point failures alone.

For the multipoint failures that result in a new unsafe condition (which are identified in step 48), an identification, step 50, is made of the features of the products, e.g., parts and operations, which may be modified to prevent or mitigate the unsafe condition resulting from the multipoint failure. If the overall risk of the product is not acceptable after step 50, then additional features are identified and considered, step 52, to reduce the risk level of the product. With these newly identified features, the hazardous operation review 40 process is repeated.

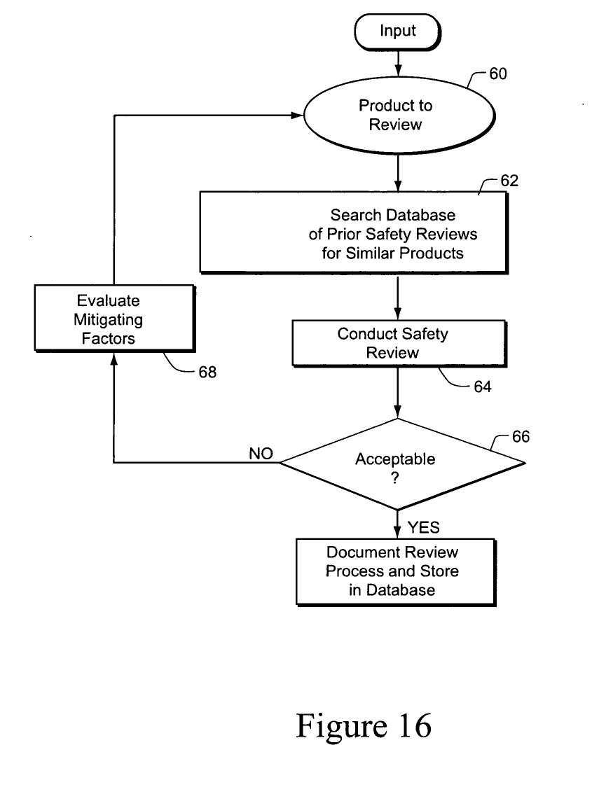

FIG. 16 shows an exemplary system schematic to perform the method steps described above and save the results of the safety review. The product 60 is readied for the safety review and a search is performed in a computer database of documentation regarding prior safety reviews, step 62. If a previous safety review conducted on a similar product is in the database, then the documentation of the safety review is obtained and reviewed in preparation for the safety review of the new product 60. Prior safety reviews provide information on hazards, unsafe conditions, failure points and mitigating factors of similar products. This information may be helpful in performing a safety review of a new product. With the documentation from prior review, a new safety review 64 is performed in accordance with the procedures shown in the preceding figures. If at the conclusion of the safety review, the safety of the product is deemed acceptable, step 66, then the documentation of the safety review process is stored in the computer database for future use. But if the product is not sufficiently safe, then additional mitigating factors are evaluated, step 68, and the product review is repeated.

A structured framework to evaluate hazards is described herein includes standardized documentation 7 to create a universal, efficient, comprehensive approach in analyzing a product to assure necessary safety requirements. Also provided is a clearly structured, simple tool set 6 (from FIG. 1) for the safety review that ensures a rigorous treatment of the product. These tools 6 ensure efficiency, by focusing the available limited time and resources on the most severe safety hazards. The present method also uses standardized tables for documentation 7 to enhance clarity and thereby provide a basis for future product enhancements. It also defines sources of safety hazards inherent to a product or a system. Further, total risks are defined by the severity (or magnitude) of personnel injury or equipment damage that could occur and the likelihood of occurrence.

In addition to the above, means to determine whether the current risk level is acceptable are provided by identifying key features that ensure acceptability. Also identified are those items that need to be better controlled to ensure an acceptable risk level. These items are identified by performing highly detailed risk analysis into specific unsafe conditions that, due to their high severity, require better control to ensure an acceptable risk level.

The present safety review process also provides for documenting diligent efforts to understand and control safety risks associated with the company product, thus providing a clear record for ensuring that safety is designed and built into future products.

The safety review process methodology may be applied to, for example, any industry, product or process. The safety review process methodology of may be administered by a focused group of facilitators in order to ensure commonality of documentation and standardization of record keeping. This method provides the ability to quickly search and identify previous similar templates when considering a new product, thus ensuring a consistent flow of the process over time and across product lines. A categorized database may be created to store the complete records of the hazard review process. This assists in performing such searches.

If a company or other organization is to effectively apply the previously disclosed Safety Review Process, the process should be efficient and rigorous. Leveraging past documentation on similar subject matter allows the process to be executed much more rapidly than performing all analysis “from scratch”. Thus “templates” of typical systems can be approved for leveraging. The use of a database to categorize and ensure ease of search and retrieval of the documentation becomes a standard requirement.

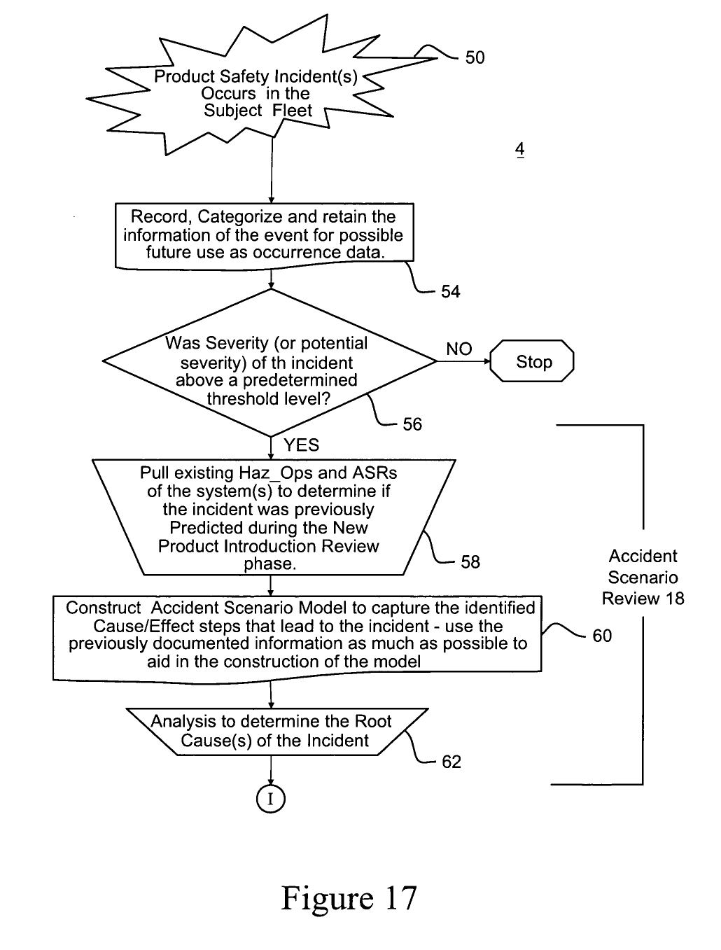

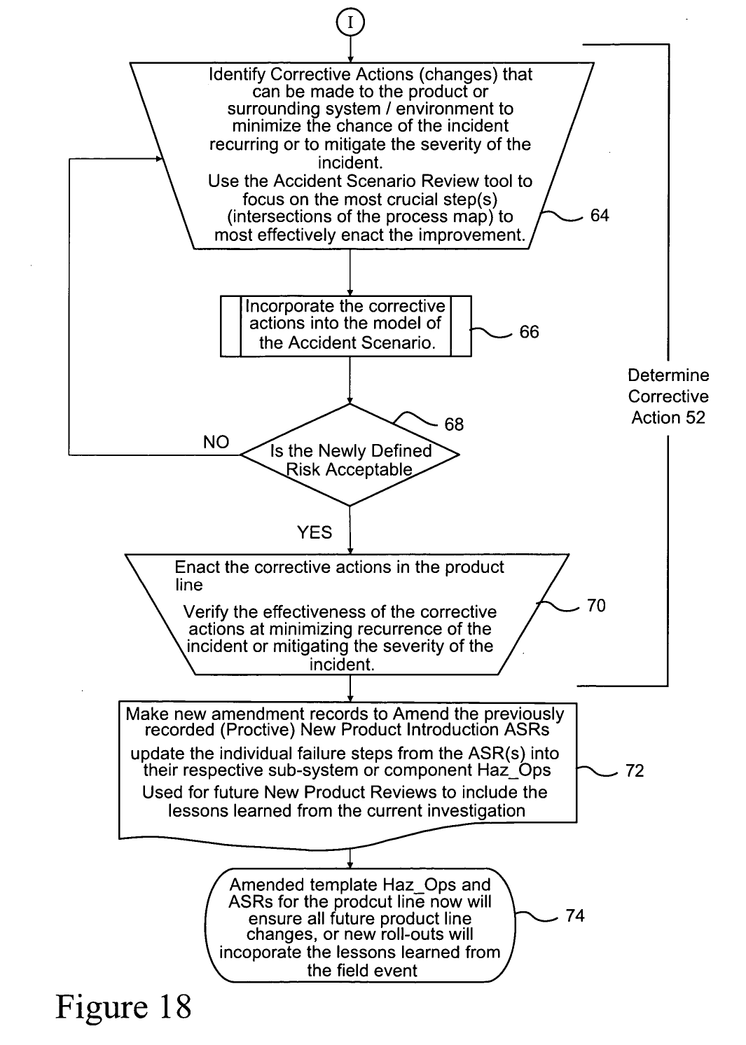

FIGS. 17 and 18 are a flow chart of a reactive safety review analysis 4 for evaluating a safety incident 6 associated with a existing product being used in the field. The safety incident may be an actual accident that occurred, a hazard identified during field use of product, or other such safety incident. A reactive safety review analysis is conducted to ensure that a safety review is conducted with respect to a significant failure mode(s) of a product that may be first identified during field use of a product. For example, a fleet of products released for field use may suffer failures that reveal safety incidents that were not previously evaluated in a safety review analysis.

The reactive safety review analysis 4 provides a feedback loop that allows for the evaluation of pertinent field safety incident(s) and yields corrective actions that may prevent or mitigate future safety incidents. When a safety incident occurs 50, a safety review team is assembled to conduct an accident scenario review (ASR) 18 (See FIG. 1) to determine the root cause(s) and to identify corrective actions 52 (FIG. 1) to avoid future safety incidents. The ASR and identification of corrective actions 52 is performed with the benefit of and by accessing the safety documentation 7 associated with the product. These documents benefit the safety review team by providing them with the knowledge of the safety controls and safety verifications the prior design team for the product put in place.

In step 50, a product safety incident occurs or a potential precursor to a safety incident occurs in the operating fleet of the product. The safety review team for the product documents 54 the safety incident so that the safety documentation 7 for the product includes a reference to the safety incident for future safety reviews.

An initial determination 56 is made as to whether the severity of the safety incident is above a threshold severity level. If the severity of the safety incident is below the threshold level, then the review is terminated.

If the severity of incident exceeds the threshold level, an accident scenario review (ASR) 18 is performed to determine the root causes of the incident and the critical steps that lead to the incident. In addition to determining and highlighting the root cause(s) of the incident, the ASR is conducted to identify controls and verifications that may added to the overall product to effectively eliminate or mitigate a reoccurrence of the safety incident.

The accident scenario review 18, in step 58, may include searches for and retrieval of any previously created and stored safety review documentation (feed forward proactive review information) to identify if the current failure mode was anticipated when the product was proactively reviewed and determine if controls were inadequate or if the current safety incident is an unanticipated event. The retrieved information may be an accident scenario model that was previously developed for a similar accident to the safety incident being analyzed. The safety documentation 7 may include a database of previously considered safety incidents, the Haz_Op and ASR analysis conducted for each incident (including the accident scenario model prepared for the incident), and any corrective actions that were performed on the product as a result of the analysis. This documentation may be applied as templates for future investigations of safety incidents. These templates allow much of the information developed during the proactive safety analysis to be conveniently reused during a reactive analysis of a safety incident.

The safety review team analyzes the safety incident by developing an accident scenario model of the incident in step 60. An accident scenario model is an analytical tool that simulates the product and one or more safety incidents. This model assists the team in identifying the causes and effects related to the safety incident. The model may exist in or be substantially derived from the safety documentation 7 that already exists for the product. If the model already exists, then the safety review team applies the model to review the current safety incident and to develop corrective actions to avoid a future occurrence of the incident. If a model for the safety incident does not exist, then another model for a similar safety incident may be applied as a template that is tailored for the current safety incident. The model is developed using effectively the same tools 6 and steps 35 used during the accident scenario review 32 in the proactive safety analysis. Using the model, the safety team determines the root causes of the safety incident in step 62.

Having modeled the safety incident and identified the root causes of the incident, the safety team determines corrective actions 52 that should prevent or mitigate reoccurrences of the safety incident. The team uses the ASR tool 18 (and may use other portions of the entire safety review tool set 6) to identify corrective actions in step 64. The corrective actions are incorporated into the model, step 66, and analyzed to determine whether they truly avoid or at least reduce the severity of the safety incident. A determination is also made as to whether the corrective actions are practical in view of the product, its surrounding system and environment. The safety team may need to evaluate various additional and alternative corrective actions, in step 68, until a set of practical corrective actions are identified that reduce the risk of the safety incident to an acceptable risk level. The acceptable changes are implemented into the product or other steps are taken to reduce the risk associated with the safety incident, in step 70.

Once an acceptable change(s) to the product is determined, applied and verified to be effective in eliminating one or more causes of the safety incident or in mitigating the severity of the incident, the incident and the change(s) are recorded and the information transferred back (feedback) to the original proactive documentation 7 of the product in step 72. The recording of the incident and the corrective actions may include amending safety documentation for the product, including the accident scenario review steps for the product, updating potential failure steps in the hazardous operation steps, and reporting lessons learned from the safety review for the incident for use in safety reviews of other products. When future changes or new but similar products are created and a proactive safety review process is undertaken with respect to the change or new product, the review process will have the benefit of an existing and up-to-date template documentation of the current product in step 74. This template documentation incorporates the lessons learned from actual safety incidents, as well as the proactive safety review of the current product.

The reactive safety review process 4 effectively carries out the proactive safety review process in reverse order. In addition, the reactive safety review process is conducted with extensive cross-talk 78 (FIG. 1) with the existing documentation 7 of the hazardous operation review and accident scenario review previously conducted and documented. A safety incident (or even a precursor that indicates a safety incident may occur) has already occurred. The incident is evaluated, step 56, to determine if it is above a threshold of severity, or potentially above the threshold of severity in the case of a precursor event to a safety incident. Previously created safety review documentation 7 of the product is searched and retrieved to identify if the event was anticipated in step 58. An accident scenario review (ASR) 18 is constructed to identify the steps leading up to the safety incident and the consequences (both real and potential) of the incident. The information from the proactive hazardous operations review(s) [Haz_Op] and ASRs is pulled and placed within the current ASR as appropriate during the cross-talk 78. The reactive ASR is conducted (in a manner similar to the ASR conducted for the proactive review) to mitigate the severity of the event in the future or to minimize the chance of recurrence of the event.

Once the reactive safety review 4 determines corrective actions 52, then the results of the review are fed back into the documentation 7 in step 80 (FIG. 1). Thus, the reactive safety review is used as a corrective feedback loop for the safety review tool set 6 that was developed during the proactive review process. The understanding of the safety incident and the controls and verifications determined to be needed to reduce the risk to an acceptable level are fed back to the existing proactive review documents 7 so that these documents can be updated and revised to account for the safety incident. The current safety incident documentation from the reactive review is recorded, categorized and saved in a database structure. The updated documentation 7 from the proactive review is similarly recorded, categorized and saved in a database structure. The crosstalk 78, 80 ensures that the product safety documentation 7 contains the current lessons learned for use in future product developments.

The reactive safety review process is facilitated by the fact that the Haz_Op 16 and ASR 18 tools developed for the proactive review have a near identical line item construct for the failure information obtained from the safety incident 5 that is the subject of the reactive review 4. This allows for the efficient “lifting” of information from the existing proactive documentation 7 to construct the ASR for the reactive review. The similarity of the ASRs for the reactive and proactive processes allows for the efficient lifting of new information from the reactive ASR to update the proactive ASR review material. Not only is the proactive ASR updated, but the information is fed back to the individual system Haz_Op. The individual system Haz_Op is a primary tool used by the individual system owner (a member of the safety review team) when changing the product design in the future to identify that no safety critical single point failures are negatively impacted.

In the recording process of the reactive safety review, an identifier made in the documentation to point to the respective records that provided the line item information, such that the original source can be traced back the original proactive review or back to the originating reactive event review.

The safety review process described herein is generic and may be applied to almost any industry, product or process. A key feature is that it is best administered by a focused group of facilitators to ensure commonality of documentation and standardization of record keeping. This ensures the ability to quickly search and identify previous similar templates when considering a new Product and ensures a consistent flow of the process over time and across product lines.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method for analyzing a product for safety in view of a safety incident associated with the product, said method comprising:
a) comparing the safety incident to a plurality of previously analyzed safety incidences stored in safety documentation for the product and selecting one of said safety incidences based on the comparison;
b) conducting an accident scenario review (ASR) of the safety incident using an existing ASR template previously developed for the selected stored safety incidence;
c) modifying the existing ASR template to reflect to suit the ASR for the safety incident;
d) based on the accident scenario review, identifying at least one corrective action which avoids or mitigates future occurrences of the safety incident, and
e) updating the safety documentation to include the tailored ASR template developed for the safety incident.

2. A method for analyzing a product for safety as in claim 1 wherein the safety incident is an accident which occurred during use of the product in fleet operation.

3. A method for analyzing a product for safety as in claim 1 wherein the safety incident is a potential accident scenario identified during use of the product.

4. A method for analyzing a product for safety as in claim 1 further comprising determining that the safety incident has a severity level above a threshold severity level before proceeding to step (a).

5. A method for analyzing a product for safety as in claim 1 wherein said ASR includes constructing an accident scenario model of the safety incident and said model is based on the tailored ASR template.

6. A method for analyzing a product for safety as in claim 1 wherein said ASR identifies at least one causation for the safety incident and said at least one corrective action is intended to prevent a future occurrence of the causation.

7. A method for analyzing a product for safety as in claim 1 wherein said documentation further comprises a database of analyzed safety incidences and corresponding ASR template.

8. A method for analyzing a product for safety as in claim 1 wherein step (c) includes creating an original ASR using the modified ASR template.

9. A method for analyzing a product for safety in view of a safety incident associated with the product, said method comprising:
a) record the safety incident in safety documentation for the product;
b) determining whether the safety incident has a severity level above a threshold severity level before proceeding to step (c);
c) comparing the safety incident to a plurality of previously analyzed safety incidences stored in the safety documentation and selecting one of said safety incidences based on the comparison;
d) developing an accident scenario model of the safety incident using as a template an existing accident scenario model developed for the selected safety incidence;
e) identifying at least one corrective action which avoids the causation of the safety incident, and
f) updating the safety documentation to include the accident scenario model developed for the safety incident.

10. A method for analyzing a product for safety as in claim 9 wherein the safety incident is an accident which occurred during use of the product in fleet operation.

11. A method for analyzing a product for safety as in claim 9 wherein the safety incident is a potential accident scenario identified during use of the product.

12. A method for analyzing a product for safety as in claim 9 further comprising determining that the safety incident has a severity level above a threshold severity level before proceeding to step (a).

13. A method for analyzing a product for safety as in claim 9 wherein said ASR includes constructing an accident scenario model of the safety incident and said model is based on the tailored ASR template.

14. A method for analyzing a product for safety as in claim 9 wherein said ASR identifies at least one causation for the safety incident and said at least one corrective action is intended to prevent a future occurrence of the causation.

15. A method for analyzing a product for safety as in claim 9 wherein said documentation further comprises a database of analyzed safety incidences and corresponding ASR template.

16. A method for analyzing a product for safety as in claim 1 wherein step (c) includes creating an original ASR using the modified ASR template.
